(19) United States
(12) Patent Application Publication
(10) Pub. No.: US 2026/0176869 A1
(43) Pub. Date: Jun. 25, 2026

(54) ASSEMBLY METHOD OF LONG-SPAN TRUSS

(71) Applicants: CHINA RAILWAY NO.4 ENGINEERING GROUP CO., LTD, Hefei (CN); THE CONSTRUCTION ENGINEERING COMPANY OF CTCE GROUP, Hefei (CN); HEFEI UNIVERSITY OF TECHNOLOGY, Hefei, Anhui (CN)

(72) Inventors: Hongyao GONG, Hefei (CN); Ruixue CAO, Hefei (CN); Gezhi XU, Hefei (CN); Manrong SONG, Hefei (CN); Wei WANG, Hefei (CN); Xudong SHENG, Hefei (CN); Huying DING, Hefei (CN); Jiaxing ZHANG, Hefei (CN); Deyuan HU, Hefei (CN); Bin DU, Hefei (CN); Ning XU, Hefei (CN); Yongli LIU, Hefei (CN); Yuan GAO, Hefei (CN)

(21) Appl. No.: 18/837,998

(22) PCT Filed: Jun. 21, 2024
(86) PCT No.: PCT/CN2024/100561

§ 371 Date: Aug. 13, 2024

(30) Foreign Application Priority Data
Nov. 3, 2023 (CN) 202311456570.7

(51) Int. Cl. E04C 3/16; B66C 1/62; E04B 1/24; E04C 3/02; E04C 3/04; E04C 3/08; E04C 3/17

(52) U.S. Cl. CPC E04C 3/16; B66C 1/62; E04C 3/02; E04C 3/08; E04C 3/17; E04B 2001/2448; E04B 2001/2454; E04C 2003/0491

(57) ABSTRACT

Disclosed is an assembly method of a long-span truss, relating to the field of construction engineering. The method includes the following steps: column-top trusses are pre-assembled at column tops of structural columns. Middle trusses are assembled on platforms between adjacent structural columns. Column-top hydraulic lifting devices are installed on the column-top trusses. Hoisting points are provided at both ends of the middle truss. The column-top hydraulic lifting devices are connected to corresponding hoisting points. The middle truss is lifted to a design height. The middle truss is connected to the column-top truss. The column-top hydraulic lifting devices are dismantled.

### TECHNICAL FIELD

The present disclosure relates to the field of construction engineering, and in particular to an assembly method of a long-span truss.

### BACKGROUND

Long-span, large-tonnage steel truss structure engineering such as large stations and convention centers are usually assembled on the ground and then hoisted to the designed height. Due to the spatial limitation of the construction site, large hoisting equipment often cannot enter the central construction area for hoisting operation, which brings certain difficulties to the hoisting of steel trusses.

### SUMMARY

Based on the problems above, a purpose of the present disclosure is to provide an assembly method of a long-span truss. The present disclosure uses the following technical solution:

An assembly method of a long-span truss includes the following steps:
S1: pre-assembling column-top trusses on column tops of structural columns;
S2: assembling middle trusses on platforms between adjacent structural columns of the structural columns;
S3: installing column-top hydraulic lifting devices on the column-top trusses, where column-top trusses at end portions of the column-top trusses each are mounted with a corresponding one of the column-top hydraulic lifting devices on one side, and each of others of the column-top trusses in a middle portion is mounted with corresponding ones of the column-top hydraulic lifting devices on both sides;
S4: providing hoisting points at both ends of each of the middle trusses;
S5: connecting each of the column-top hydraulic lifting devices to a corresponding one of the hoisting points;
S6: lifting the middle trusses to a designed height;
S7: connecting the middle trusses to the column-top trusses respectively; and
S8: dismantling the column-top hydraulic lifting devices.

Further, in Step S2, when one of the middle trusses is composed of two sections with different heights, the method includes the following steps:
S21: assembling a higher truss and a lower truss on a corresponding one of the platforms;
S22: installing a middle hydraulic lifting device on one side, adjacent to the lower truss, of the higher truss, and providing the hoisting points at both ends of the lower truss, and on one side, away from the lower truss, of the higher truss, respectively;
S23: connecting each of the column-top hydraulic lifting devices and the middle hydraulic lifting device to a corresponding one of the hoisting points;
S24: lifting the lower truss to a height where the higher truss is located, and then connecting the lower truss to the higher truss; and
S25: dismantling the middle hydraulic lifting device.

Further, each of the column-top hydraulic lifting devices includes:
a first lifting crossbeam connected to a top chord of a corresponding one of the column-top trusses;
three first web members, where two of the first web members are arranged on both sides of the first lifting crossbeam, and an other one of the first web members is arranged below the first lifting crossbeam; both ends of the two of the first web members on both sides of the first lifting crossbeam are respectively connected to the first lifting crossbeam and the top chord of the corresponding one of the column-top trusses, and both ends of the other one of the first web members below the first lifting crossbeam are respectively connected to the first lifting crossbeam and a corresponding one of the structural columns; and
a first hydraulic lifter arranged on the first lifting crossbeam, and connected to a corresponding one of the hoisting points.

Further, each of the column-top hydraulic lifting devices includes:
a second lifting crossbeams arranged parallel to and spaced above a bottom chord of a corresponding one of the column-top trusses, and connected to a corresponding one of the structural columns;
a second web member obliquely arranged between the second lifting crossbeam and the bottom chord of the corresponding one of the column-top trusses, where both ends of the second web member are respectively connected to the second lifting crossbeam and the corresponding one of the structural columns; and
a second hydraulic lifter arranged on the second lifting crossbeam, and connected to a corresponding one of the hoisting points.

Further, each of the column-top hydraulic lifting devices includes:
two third lifting crossbeams, where the two third lifting crossbeams are arranged above a bottom chord of a corresponding one of the column-top trusses in an L-shaped structure in a horizontal direction, and connected to a corresponding one of the structural columns; and one of the third lifting crossbeams is parallel to the bottom chord of the corresponding one of the column-top trusses;
first stiffeners, where a top surface and a bottom surface of each of the third lifting crossbeams are both provided with the first stiffeners, and both ends of each of the first stiffeners are respectively connected to a corresponding one of the third lifting crossbeams and the corresponding one of the structural columns; and
third hydraulic lifters, where each of the third lifting crossbeams is provided with a corresponding one of the third hydraulic lifters, and the third hydraulic lifters are connected to corresponding ones of the hoisting points.

Further, each of the column-top hydraulic lifting devices includes:
two fourth lifting crossbeams, where the two fourth lifting crossbeams are linearly arranged above a bottom chord of a corresponding one of the column-top trusses in a horizontal direction, and connected to a corresponding one of the structural columns; and the fourth lifting crossbeams are parallel to the bottom chord of the corresponding one of the column-top trusses;
second stiffeners, where a top surface and a bottom surface of each of the fourth lifting crossbeams are both provided with the second stiffeners, and both ends of each of the second stiffeners are respectively connected to a corresponding one of the fourth lifting crossbeams and the corresponding one of the structural columns; and
fourth hydraulic lifters, where each of the fourth lifting crossbeams is provided with a corresponding one of the fourth hydraulic lifters, and the fourth hydraulic lifters are connected to corresponding ones of the hoisting points.

Further, the middle hydraulic lifting device includes:
a fifth lifting crossbeam arranged on a top surface of top chords of the higher truss, where both ends of the fifth lifting crossbeam are respectively connected to the top chords of the higher truss;
two third web members, where the two third web members are arranged in a V shape, and both ends of each of the third web members are connected to the fifth lifting crossbeam and a bottom chord of the higher truss; and
a fifth hydraulic lifter arranged on the fifth lifting crossbeam and connected to a corresponding one of the hoisting points.

Further, the middle hydraulic lifting device includes:
two vertical bars, where the two vertical bars are arranged side by side and at intervals, and bottom ends of the vertical bars are connected to top chords of the higher truss;
two horizontal bars, where the two horizontal bars are arranged side by side and at intervals, one ends of the horizontal bars are respectively connected to tops of the vertical bars, and other ends of the horizontal bars extend towards a direction of the lower truss;
a sixth lifting crossbeam arranged above sides, away from the vertical bars, of the horizontal bars, where both ends of the sixth lifting crossbeam are respectively connected to the horizontal bars;
two fourth web members, where the two fourth web members are arranged, side by side and at intervals, on both sides below the sixth lifting crossbeam, one end of each of the fourth web members is connected to the sixth lifting crossbeam, an other end of each of the fourth web members extends obliquely downward towards a direction close to the vertical bar and is connected to a bottom chord of the higher truss;
a connecting bar arranged between the two vertical bars, where both ends of the connecting bar are connected to the tops of the vertical bars;
two rear tie bars, where the two rear tie bars are arranged on sides, away from the horizontal bars, of the vertical bars side by side and at intervals, one ends of the rear tie bars are connected to the tops of the vertical bars, and other ends of the rear tie bars extend obliquely downward towards a direction away from the horizontal bars and are connected to the top chords of the higher truss; and
a sixth hydraulic lifter arranged on the sixth lifting crossbeam, and connected to a corresponding one of the hoisting points.

Further, the middle hydraulic lifting device includes:
a seventh lifting crossbeam arranged above top chords of the higher truss, where both ends of the seventh lifting crossbeam are respectively connected to the top chords of the higher truss;
two fifth web members, where the two fifth web members are arranged on both sides below the seventh lifting crossbeam side by side, and both ends of each of the fifth web members are respectively connected to the seventh lifting crossbeam and a bottom chord of the higher truss; and
a seventh hydraulic lifter arranged on the seventh lifting crossbeam, and connected to a corresponding one of the hoisting points.

Compared with the prior art, the present disclosure achieves beneficial effects as follows:

By providing a column-top truss on a column top of a structural column and using the column-top truss as a mounting frame of a column-top hydraulic lifting device, the middle truss can be lifted after being assembled, then an effect of assembling the middle truss and the column-top truss can be achieved, and the problem that large lifting equipment often cannot enter a central construction area for hoisting operation due to the space limitation of a construction site is solved.

### BRIEF DESCRIPTION OF THE DRAWINGS

The present disclosure is further described below with reference to accompanying drawings.

FIG. 1 is a schematic diagram of an assembly structure of long-span trusses according to the present disclosure;

FIG. 2 is a side view of a column-top hydraulic lifting device according to Embodiment 2 of the present disclosure;

FIG. 3 is another side view of the column-top hydraulic lifting device according to Embodiment 2 of the present disclosure;

FIG. 4 is a schematic diagram of a three-dimensional structure of a column-top hydraulic lifting device according to Embodiment 3 of the present disclosure;

FIG. 5 is a schematic diagram of a three-dimensional structure of a column-top hydraulic lifting device according to Embodiment 4 of the present disclosure;

FIG. 6 is a schematic diagram of a three-dimensional structure of a column-top hydraulic lifting device according to Embodiment 5 of the present disclosure;

FIG. 7 is a schematic diagram of a three-dimensional structure of a middle hydraulic lifting device according to Embodiment 6 of the present disclosure;

FIG. 8 is a side view of the middle hydraulic lifting device according to Embodiment 6 of the present disclosure;

FIG. 9 is a side view of a middle hydraulic lifting device according to Embodiment 7 of the present disclosure;

FIG. 10 is a top view of the middle hydraulic lifting device according to Embodiment 7 of the present disclosure; and

FIG. 11 is a schematic diagram of a three-dimensional structure of a middle hydraulic lifting device according to Embodiment 8 of the present disclosure.

Numeral references are as follows: 1 structural column; 2 column-top truss; 3 middle truss; 31 higher truss; 32 lower truss; 4 column-top hydraulic lifting device; 41-1 first lifting crossbeam; 41-2 second lifting crossbeam; 41-3 third lifting crossbeam; 41-4 fourth lifting crossbeam; 42-1 first web member; 42-2 second web member; 42-3 first stiffener; 42-4 second stiffener; 43-1 first hydraulic lifter; 43-2 second hydraulic lifter; 43-3 third hydraulic lifter; 43-4 fourth hydraulic lifter; 5 middle hydraulic lifting device; 51-1 fifth lifting crossbeam; 51-2 vertical bar; 52-1 third web member; 52-2 horizontal bar; 53-1 fifth hydraulic lifter; 53-2 sixth lifting crossbeam; 53-3 seventh lifting crossbeam; 54-2 fourth web member; 54-3 fifth web member; 55-2 connecting bar; 56-2 rear tie bar; 57-2 sixth hydraulic lifter; 57-3 seventh hydraulic lifter; 6 hoisting point.

### DETAILED DESCRIPTION OF THE EMBODIMENTS

In order to make the technical problem to be solved by the present disclosure, technical solutions and advantages of the present disclosure more clearly, the present disclosure is further described in detail below with reference to the accompanying drawings and embodiments.

### Embodiment 1

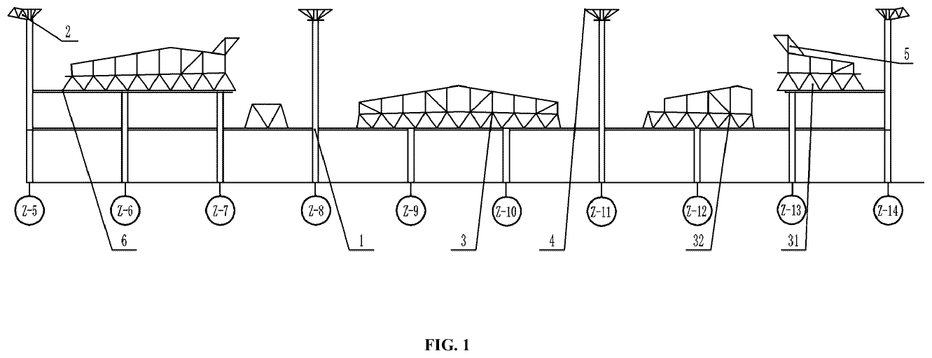

As shown in FIG. 1, an assembly method of a long-span truss is disclosed in this embodiment, including the following steps: S1. Column-top trusses 2 are pre-assembled at column tops of structural columns 1. Parts of the truss are pre-assembled at the column tops of the structural columns 1 according to a design drawing.

S2. Middle truss 3 are assembled on platforms between adjacent structural columns 1. The remaining parts of the truss are assembled on the platforms between the adjacent structural columns 1 according to the design drawing.

S3. Column-top hydraulic lifting devices 4 are installed on the column-top trusses 2, where column-top trusses 2 at end portions each are mounted with a the column-top hydraulic lifting device, and column-top trusses 2 in a middle portion is mounted with the column-top hydraulic lifting devices 4 on both sides.

S4. Hoisting points 6 are provided at both ends of the middle truss 3. The hoisting points 6 are respectively arranged at both ends of a bottom chord of the middle truss 3.

S5. The column-top hydraulic lifting devices 4 are connected to corresponding hoisting points 6. The hoisting points 6 at both ends of the middle truss 3 are respectively connected to action ends of the corresponding column-top hydraulic lifting devices 4 above.

S6. The middle truss 3 is lifted to a designed height. By controlling the column-top hydraulic lifting devices 4 to lift at the same time, the middle truss 3 is driven to move upwards until the middle truss 3 is lifted to the designed height.

S7. The middle truss 3 is connected to the column-top trusses 2.

S8. The column-top hydraulic lifting devices 4 are dismantled.

By providing a column-top truss 2 on a column top of a structural column 1 and using the column-top truss 2 as a mounting frame of a column-top hydraulic lifting device 4, the middle truss 3 can be lifted after being assembled, then an effect of assembling the middle truss 3 and the column-top truss 2 can be achieved, and the problem that large lifting equipment often cannot enter a central construction area for hoisting operation due to the space limitation of a construction site is solved. In addition, this method can enlarge the construction working surface and further improve the construction efficiency.

In a further optimized solution, in Step S2, when the middle truss 3 is composed of two sections with different heights, the method includes the following steps:

S21. A higher truss 31 and a lower truss 32 are assembled on the platform, respectively. The higher truss 31 is assembled at a high position of the platform and the lower truss 32 is assembled at a lower position of the platform according to the design drawing.

S22. A middle hydraulic lifting device 5 is installed on one side, adjacent to the lower truss 32, of the higher truss 31, and the hoisting points 6 are respectively provided at both ends of the lower truss 32, and one side, away from the lower truss 32, of the higher truss 31.

S23. The column-top hydraulic lifting devices 4 and the middle hydraulic lifting device 5 are connected to the corresponding hoisting points 6, respectively.

S24. The lower truss 32 is lifted to a height where the higher truss 31 is located, and then the lower truss 32 and the higher truss 31 are connected together.

S25. The middle hydraulic lifting device 5 is dismantled.

By using this solution, the middle hydraulic lifting device 5 and the column-top hydraulic lifting device 4 can be used in cooperation to achieve an effect of lifting the lower truss 32, and then the effect of lifting the lower truss 32 and the higher truss 31 after the lower truss 32 is connected to the higher truss 31 can be achieved.

### Embodiment 2

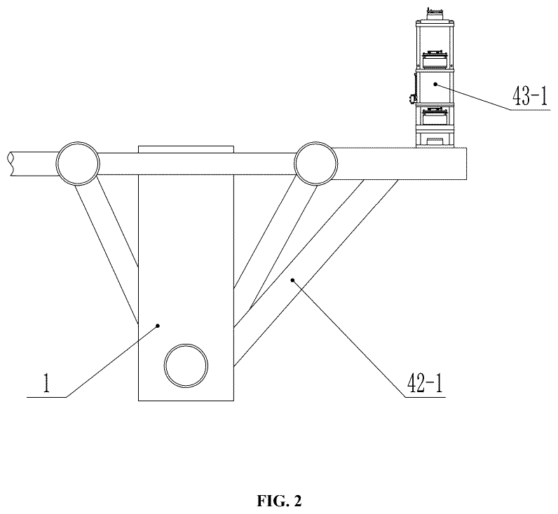

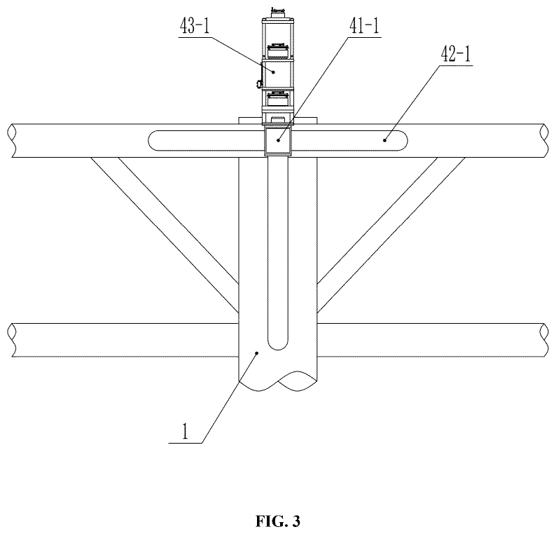

As shown in FIG. 2 to FIG. 3, an assembly method of a long-span truss is disclosed by this embodiment, and the description of the method part is the same as that in Embodiment 1.

A structure of the column-top hydraulic lifting device 4 is designed in detail in this embodiment. Specifically, the column-top hydraulic lifting device 4 includes a first lifting crossbeam 41-1, first web members 42-1, and a first hydraulic lifter 43-1. The first lifting crossbeam 41-1 is horizontally arranged, one end of the first lifting crossbeam 41-1 is welded to a top chord of the column-top truss 2. Three first web members 42-1 are provided, two of the first web members 42-1 are horizontally arranged on both sides of the first lifting crossbeam 41-1, and the other first web member 42-1 is obliquely arranged below the first lifting crossbeam 41-1. Both ends of the first web members 42-1 on both sides of the first lifting crossbeam 41-1 are respectively welded to the first lifting crossbeam 41-1 and the top chord of the column-top truss 2; and both ends of the first web member 42-1 below the first lifting crossbeam 41-1 are respectively welded to the first lifting crossbeam 41-1 and the structural column 1. The first hydraulic lifter 43-1 is fixedly installed at the middle part of a top surface of the first lifting crossbeam 41-1, and an action end of the first hydraulic lifter 43-1 is connected to a corresponding hoisting point 6.

### Embodiment 3

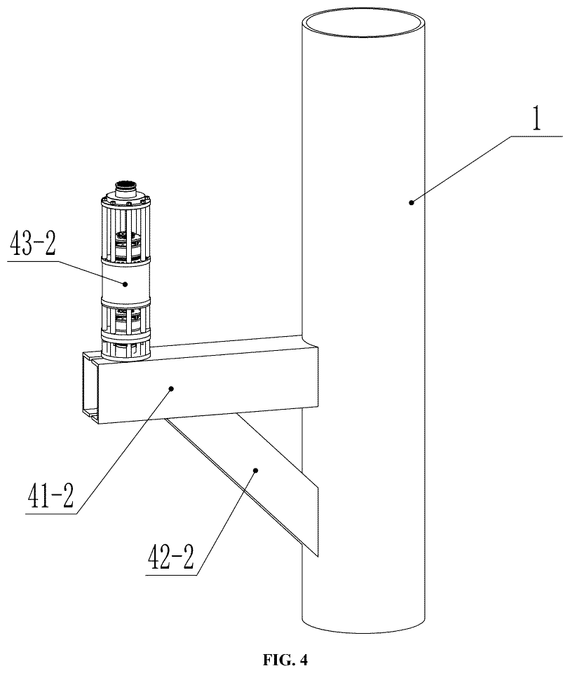

As shown in FIG. 4, an assembly method of a long-span truss is disclosed by this embodiment, and the description of the method part is the same as that in Embodiment 1.

A structure of the column-top hydraulic lifting device 4 is designed in detail in this embodiment. Specifically, the column-top hydraulic lifting device 4 includes a second lifting crossbeam 41-2, a second web member 42-2, and a second hydraulic lifter 43-2. The second lifting crossbeam 41-2 is arranged parallel to and spaced above a bottom chord of the column-top truss 2, and one end of the second lifting crossbeam 41-2 is welded to the structural column 1. The second web member 42-2 is obliquely arranged between the second lifting crossbeam 41-2 and the bottom chord of the column-top truss 2, and both ends of the second web member 42-2 are respectively welded to the second lifting crossbeam 41-2 and the structural column 1. The second hydraulic lifter 43-2 is fixedly installed on a top surface of the second lifting crossbeam 41-2, and an action end of the second hydraulic lifter 43-2 is connected to a corresponding hoisting point 6.

### Embodiment 4

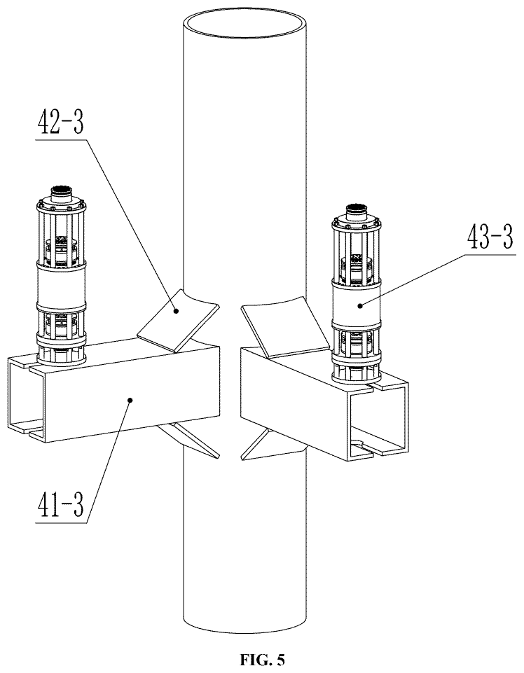

As shown in FIG. 5, an assembly method of a long-span truss is disclosed by this embodiment, and the description of the method part is the same as that in Embodiment 1.

A structure of the column-top hydraulic lifting device 4 is designed in detail in this embodiment. Specifically, the column-top hydraulic lifting device 4 includes third lifting crossbeams 41-3, first stiffeners 42-3, and third hydraulic lifters 43-3. Two third lifting crossbeams 41-3 are provided, which are arranged above the bottom chord of the column-top truss 2 in an L-shaped structure in a horizontal direction, and welded to the structural column 1. One of the third lifting crossbeams 41-3 is parallel to the bottom chord of the column-top truss 2. A top surface and a bottom surface of the third lifting crossbeam 41-3 are both provided with the first stiffeners 42-3, and both ends of each first stiffener 42-3 are respectively welded to the third lifting crossbeam 41-3 and the structural column 1. The third hydraulic lifter 43-3 is fixedly installed on each third lifting crossbeam 41-3, and an action end of the third hydraulic lifter 43-3 is connected to a corresponding hoisting point 6.

### Embodiment 5

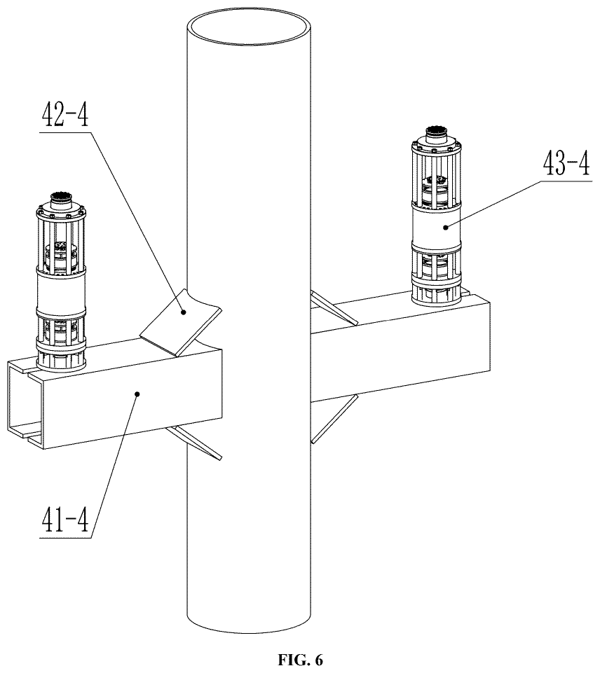

As shown in FIG. 6, an assembly method of a long-span truss is disclosed by this embodiment, and the description of the method part is the same as that in Embodiment 1.

A structure of the column-top hydraulic lifting device 4 is designed in detail in this embodiment. Specifically, the column-top hydraulic lifting device 4 includes fourth lifting crossbeams 41-4, second stiffeners 42-4, and fourth hydraulic lifters 43-4. Two fourth lifting crossbeams 41-4 are provided, which are linearly arranged above the bottom chord of the column-top truss 2 in a horizontal direction, and are respectively welded to the structural column 1, and parallel to the bottom chord of the column-top truss 2. A top surface and a bottom surface of each fourth lifting crossbeam 41-4 are both provided with the second stiffeners 42-4, and both ends of each second stiffener 42-4 are respectively welded to the fourth lifting crossbeam 41-4 and the structural column 1. The fourth hydraulic lifter 43-4 is fixedly installed on each fourth lifting crossbeam 41-4, and an action end of the fourth hydraulic lifter 43-4 is connected to a corresponding hoisting point 6.

### Embodiment 6

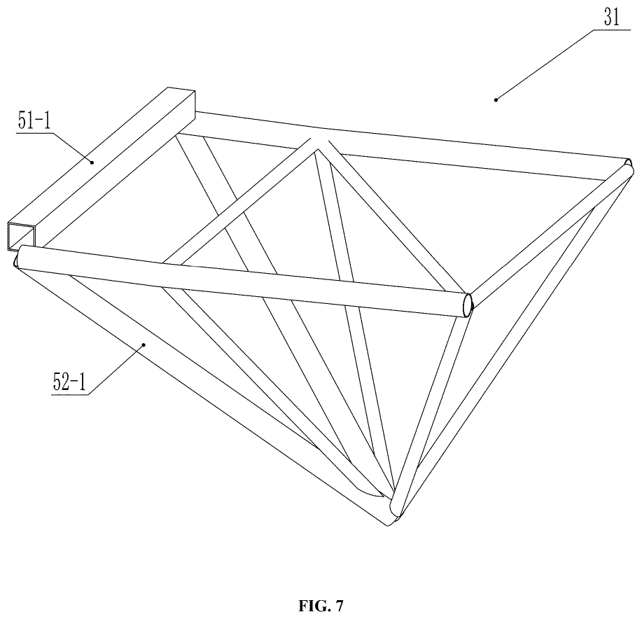

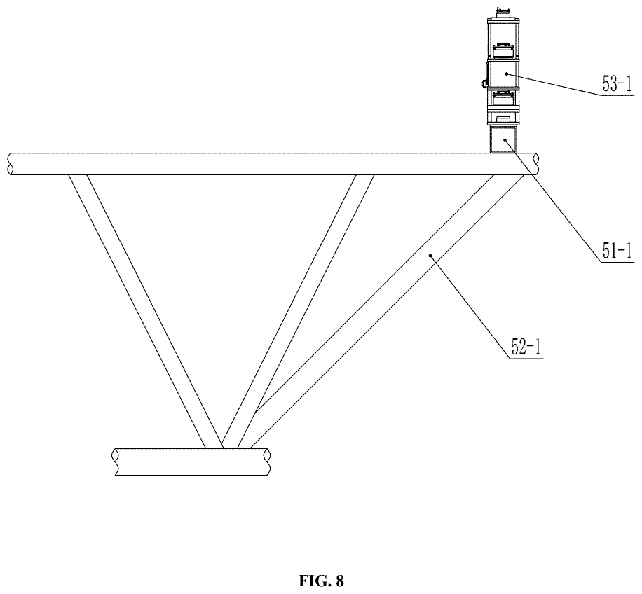

As shown in FIG. 7 to FIG. 8, an assembly method of a long-span truss is disclosed by this embodiment, and the description of the method part is the same as that in Embodiment 1.

A structure of the middle hydraulic lifting device 5 is designed in detail in this embodiment. Specifically, the middle hydraulic lifting device 5 includes a fifth lifting crossbeam 51-1, third web members 52-1, and a fifth hydraulic lifter 53-1. The fifth lifting crossbeam 51-1 is arranged on a top surface of a top chord of the higher truss 31, and both ends of the fifth lifting crossbeam 51-1 are respectively welded to the top chords of the higher truss 31. Two third web members 52-1 are provided, which are arranged in a V shape. Both ends of each third web member 52-1 are respectively welded to the fifth lifting crossbeam 51-1 and a bottom chord of the higher truss 31. The fifth hydraulic lifter 53-1 is fixedly installed on the top surface of the fifth lifting crossbeam 51-1, and an action end of the fifth hydraulic lifter 53-1 is connected to a corresponding hoisting point 6.

The middle hydraulic lifting device 5 in this embodiment can be used in cooperation with any column-top hydraulic lifting device 4 in the above Embodiments 2 to 5.

### Embodiment 7

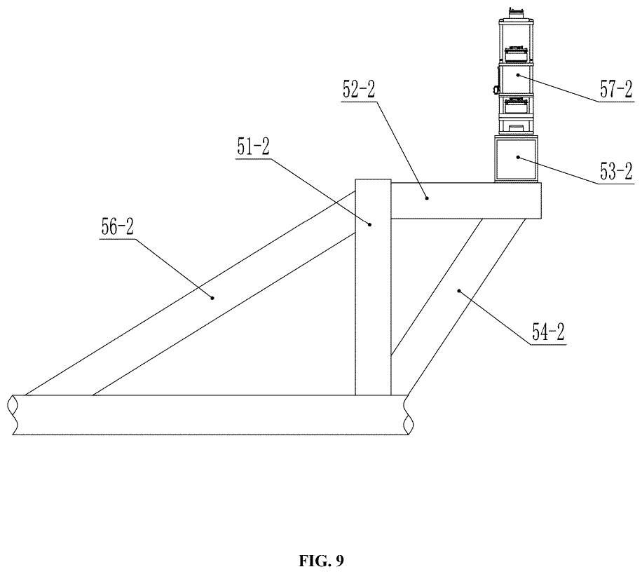

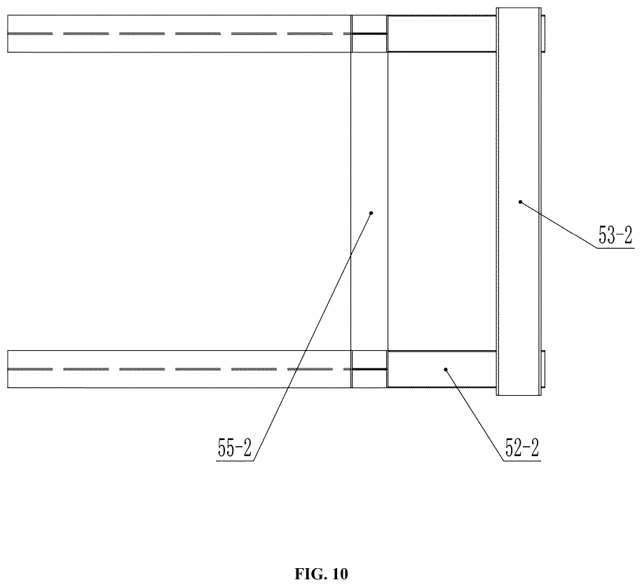

As shown in FIG. 9 to FIG. 10, an assembly method of a long-span truss is disclosed by this embodiment, and the description of the method part is the same as that in Embodiment 1.

A structure of the middle hydraulic lifting device 5 is designed in detail in this embodiment. Specifically, the middle hydraulic lifting device 5 includes vertical bars 51-2, horizontal bars 52-2, a sixth lifting crossbeam 53-2, fourth web members 54-2, a connecting bar 55-2, rear tie bars 56-2, and a sixth hydraulic lifter 57-2. Two vertical bars 51-2 are provided, which are arranged side by side and at intervals, and bottom ends of the vertical bars 51-2 are welded to the top chords of the higher truss 31. Two horizontal bars 52-2 are provided, which are arranged side by side and at intervals, one end of each horizontal bar 52-2 is welded to the top of the vertical bar 51-2, and the other end of the horizontal bar 52-2 extends towards a direction of the lower truss 32. The sixth lifting crossbeam 53-2 is arranged above sides, away from the vertical bar 51-2, of the horizontal bars 52-2, and both ends of the sixth lifting crossbeam 53-2 are respectively welded to the horizontal bars 52-2. Two fourth web members 54-2 are provided, which are arranged on both sides below the sixth lifting crossbeam 53-2 side by side and at intervals. One end of each fourth web member 54-2 is welded to the sixth lifting crossbeam 53-2, the other end of the fourth web member 54-2 extends obliquely downward towards a direction close to the vertical bar 51-2 and is welded to a bottom chord of the higher truss 31. The connecting bar 55-2 is arranged between the two vertical bars 51-2, and both ends of the connecting bar 55-2 are respectively welded to the tops of the vertical bars. Two rear tie bars 56-2 are provided, which are arranged on sides, away from the horizontal bar 52-2, of the vertical bars 51-2 side by side and at intervals, one end of each rear tie bar 56-2 is welded to the top of the vertical bar 51-2, and the other end of the rear tie bar 56-2 extends obliquely downward towards a direction away from the horizontal bar 52-2 and is connected to the top chords of the higher truss 31. The sixth hydraulic lifter 57-2 is fixedly installed on the top surface of the sixth lifting crossbeam 53-2, and an action end of the sixth hydraulic lifter 57-2 is connected to a corresponding hoisting point 6.

The middle hydraulic lifting device 5 in this embodiment can be used in cooperation with any column-top hydraulic lifting device 4 in the above Embodiments 2 to 5.

### Embodiment 8

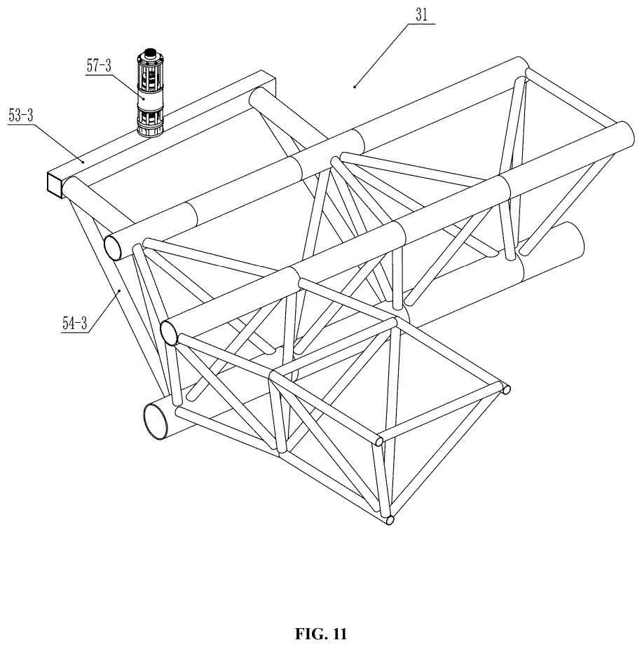

As shown in FIG. 11, an assembly method of a long-span truss is disclosed by this embodiment, and the description of the method part is the same as that in Embodiment 1.

A structure of the middle hydraulic lifting device 5 is designed in detail in this embodiment. Specifically, the middle hydraulic lifting device 5 includes a seventh lifting crossbeam 53-3, fifth web members 54-3, and a seventh hydraulic lifter 57-3. The seventh lifting crossbeam 53-3 is arranged above the top chords of the higher truss 31, and both ends of the seventh lifting crossbeam 53-3 are respectively welded to the top chords of the higher truss 31. Two fifth web members 54-3 are provided, which are arranged on both sides below the seventh lifting crossbeam 53-3 side by side, and both ends of each fifth web member 54-3 are respectively welded to the seventh lifting crossbeam 53-3 and the bottom chord of the higher truss 31. The seventh hydraulic lifter 57-3 is fixedly installed on the top surface of the seventh lifting crossbeam 53-3, and an action end of the seventh hydraulic lifter 57-3 is connected to a corresponding hoisting point 6.

The middle hydraulic lifting device 5 in this embodiment can be used in cooperation with any column-top hydraulic lifting device 4 in the above Embodiments 2 to 5.

It should be noted that the hydraulic lifters mentioned in the above Embodiments 2 to 8 are all in the prior art, and working principles and usage methods thereof are all known, and thus will not be repeated here.

The above embodiments are only the description of the preferred modes of the present disclosure, and are not intended to limit the scope of the present disclosure. Various modifications and improvements made by those of ordinary skill in the art to the technical solution of the present disclosure without departing from the design spirit of the present disclosure shall fall within the scope of protection determined by the claims of the present disclosure.

1. An assembly method of a long-span truss, the assembly method comprising:
S1: pre-assembling column-top trusses on column tops of structural columns;
S2: assembling middle trusses on platforms between adjacent structural columns the structural columns;
S3: installing column-top hydraulic lifting devices on the column-top trusses, wherein column-top trusses at end portions of the column-top trusses each are mounted with a corresponding one of the column-top hydraulic lifting devices on one side, and each of others of the column-top trusses in a middle portion is mounted with corresponding ones of the column-top hydraulic lifting devices on both sides;
S4: providing hoisting points at both ends of each of the middle trusses;
S5: connecting each of the column-top hydraulic lifting devices to a corresponding one of the hoisting points;
S6: lifting the middle trusses to a designed height;
S7: connecting the middle trusses to the column-top trusses respectively; and
S8: dismantling the column-top hydraulic lifting devices.

2. The assembly method of a long-span truss according to claim 1, wherein in Step S2, when one of the middle trusses is composed of two sections with different heights, the method comprises the following steps:
S21: assembling a higher truss and a lower truss on a corresponding one of the platforms;
S22: installing a middle hydraulic lifting device on one side, adjacent to the lower truss, of the higher truss, and providing the hoisting points at both ends of the lower truss, and on one side, away from the lower truss, of the higher truss, respectively;
S23: connecting each of the column-top hydraulic lifting devices and the middle hydraulic lifting device to a corresponding one of the hoisting points;
S24: lifting the lower truss to a height where the higher truss is located, and then connecting the lower truss to the higher truss; and
S25: dismantling the middle hydraulic lifting device.

3. The assembly method of a long-span truss according to claim 2, wherein each of the column-top hydraulic lifting devices comprises:
a first lifting crossbeam connected to a top chord of a corresponding one of the column-top trusses;
three first web members, wherein two of the first web members are arranged on both sides of the first lifting crossbeam, and an other one of the first web members is arranged below the first lifting crossbeam; both ends of the two of the first web members on both sides of the first lifting crossbeam are respectively connected to the first lifting crossbeam and the top chord of the corresponding one of the column-top trusses, and both ends of the other one of the first web members below the first lifting crossbeam are respectively connected to the first lifting crossbeam and a corresponding one of the structural columns; and
a first hydraulic lifter arranged on the first lifting crossbeam, and connected to a corresponding one of the hoisting points.

4. The assembly method of a long-span truss according to claim 2, wherein each of the column-top hydraulic lifting devices comprises:
a second lifting crossbeams arranged parallel to and spaced above a bottom chord of a corresponding one of the column-top trusses, and connected to a corresponding one of the structural columns;
a second web member obliquely arranged between the second lifting crossbeam and the bottom chord of the corresponding one of the column-top trusses, wherein both ends of the second web member are respectively connected to the second lifting crossbeam and the corresponding one of the structural columns; and
a second hydraulic lifter arranged on the second lifting crossbeam, and connected to a corresponding one of the hoisting points.

5. The assembly method of a long-span truss according to claim 2, wherein each of the column-top hydraulic lifting devices comprises:
two third lifting crossbeams, wherein the two third lifting crossbeams are arranged above a bottom chord of a corresponding one of the column-top trusses in an L-shaped structure in a horizontal direction, and connected to a corresponding one of the structural columns; and one of the third lifting crossbeams is parallel to the bottom chord of the corresponding one of the column-top trusses;
first stiffeners, wherein a top surface and a bottom surface of each of the third lifting crossbeams are both provided with the first stiffeners, and both ends of each of the first stiffeners are respectively connected to a corresponding one of the third lifting crossbeams and the corresponding one of the structural columns; and
third hydraulic lifters, wherein each of the third lifting crossbeams is provided with a corresponding one of the third hydraulic lifters, and the third hydraulic lifters are connected to corresponding ones of the hoisting points.

6. The assembly method of a long-span truss according to claim 2, wherein each of the column-top hydraulic lifting devices comprises:
two fourth lifting crossbeams, wherein the two fourth lifting crossbeams are linearly arranged above a bottom chord of a corresponding one of the column-top trusses in a horizontal direction, and connected to a corresponding one of the structural columns; and the fourth lifting crossbeams are parallel to the bottom chord of the corresponding one of the column-top trusses;
second stiffeners, wherein a top surface and a bottom surface of each of the fourth lifting crossbeams are both provided with the second stiffeners, and both ends of each of the second stiffeners are respectively connected to a corresponding one of the fourth lifting crossbeams and the corresponding one of the structural columns; and
fourth hydraulic lifters, wherein each of the fourth lifting crossbeams is provided with a corresponding one of the fourth hydraulic lifters, and the fourth hydraulic lifters are connected to corresponding ones of the hoisting points.

7. The assembly method of a long-span truss according to claim 2, wherein the middle hydraulic lifting device comprises:
a fifth lifting crossbeam arranged on a top surface of top chords of the higher truss, wherein both ends of the fifth lifting crossbeam are respectively connected to the top chords of the higher truss;
two third web members, wherein the two third web members are arranged in a V shape, and both ends of each of the third web members are connected to the fifth lifting crossbeam and a bottom chord of the higher truss; and
a fifth hydraulic lifter arranged on the fifth lifting crossbeam and connected to a corresponding one of the hoisting points.

8. The assembly method of a long-span truss according to claim 2, wherein the middle hydraulic lifting device comprises:
two vertical bars, wherein the two vertical bars are arranged side by side and at intervals, and bottom ends of the vertical bars are connected to top chords of the higher truss;
two horizontal bars, wherein the two horizontal bars are arranged side by side and at intervals, one ends of the horizontal bars are respectively connected to tops of the vertical bars, and other ends of the horizontal bars extend towards a direction of the lower truss;
a sixth lifting crossbeam arranged above sides, away from the vertical bars, of the horizontal bars, wherein both ends of the sixth lifting crossbeam are respectively connected to the horizontal bars;
two fourth web members, wherein the two fourth web members are arranged, side by side and at intervals, on both sides below the sixth lifting crossbeam, one end of each of the fourth web members is connected to the sixth lifting crossbeam, an other end of each of the fourth web members extends obliquely downward towards a direction close to the vertical bar and is connected to a bottom chord of the higher truss;
a connecting bar arranged between the two vertical bars, wherein both ends of the connecting bar are connected to the tops of the vertical bars;
two rear tie bars, wherein the two rear tie bars are arranged on sides, away from the horizontal bars, of the vertical bars side by side and at intervals, one ends of the rear tie bars are connected to the tops of the vertical bars (51-2), and other ends of the rear tie bars extend obliquely downward towards a direction away from the horizontal bars and are connected to the top chords of the higher truss; and
a sixth hydraulic lifter arranged on the sixth lifting crossbeam, and connected to a corresponding one of the hoisting points.

9. The assembly method of a long-span truss according to claim 2, wherein the middle hydraulic lifting device comprises:
a seventh lifting crossbeam arranged above top chords of the higher truss, wherein both ends of the seventh lifting crossbeam are respectively connected to the top chords of the higher truss;
two fifth web members, wherein the two fifth web members are arranged on both sides below the seventh lifting crossbeam side by side, and both ends of each of the fifth web members are respectively connected to the seventh lifting crossbeam and a bottom chord of the higher truss; and
a seventh hydraulic lifter arranged on the seventh lifting crossbeam, and connected to a corresponding one of the hoisting points.
